(19) United States
(12) Patent Application Publication
(10) Pub. No.: US 2015/0254937 A1
(43) Pub. Date: Sep. 10, 2015

(54) SPORTS BOOK SYSTEMS AND METHODS FOR COMPETING WITH INDIVIDUALS AND/OR COMPANIES, ORGANIZATIONS, OR ARTISTS

(71) Applicant: Sportsballer LLC, Zephyr Cove, NV (US)

(72) Inventor: Christian Sanchez, Upland, CA (US)

(21) Appl. No.: 14/639,724

(22) Filed: Mar. 5, 2015

Related U.S. Application Data
(60) Provisional application No. 61/949,099, filed on Mar. 6, 2014.

(51) Int. Cl. G07F 17/32

(52) U.S. Cl. CPC G07F 17/3288; G07F 17/3244

(57) ABSTRACT

A computer system may include instructions recorded on a non-transitory computer-readable storage medium and readable by at least one processor. The system may include a game generation module, a sponsor selection module, a participant selection module, a grading module, and a results module. The game generation module is configured to receive a first set of parameters from a first sponsor and is configured to receive a second set of parameters from a second sponsor. The sponsor selection module is configured to receive a first set of game selections from the first sponsor and is configured to receive a second set of game selections from the second sponsor. The participant selection module is configured to receive a third set of game selections from a participant.

### CROSS-REFERENCE TO RELATED APPLICATION

This application is a Nonprovisional of, and claims priority to, U.S. Patent Application No. 61/949,099, filed on Mar. 6, 2014, entitled “SPORTS BOOK SYSTEMS AND METHODS FOR COMPETING WITH INDIVIDUALS AND/OR COMPANIES, ORGANIZATIONS, OR ARTISTS”, which is incorporated by reference herein in its entirety.

### TECHNICAL FIELD

This description relates to the sports book system and methods for competing with individuals and companies/organizations/artists and evaluating individual's performance for entertainment purposes.

### BACKGROUND

Many people compete in contests hosted or sponsored by companies, such as retail stores, restaurants, etc. Often times, the contests hosted or sponsored by companies form part of a marketing or advertisement campaign for the companies. Additionally, many people enjoy following sports and placing wagers on sporting events, including individual and team sports.

Accordingly, there is a need for a sports book system and method that allows companies to engage users in sports related contests.

### SUMMARY

In some embodiments, a computer system may include instructions recorded on a non-transitory computer-readable storage medium and readable by at least one processor. The system may include a game generation module, a sponsor selection module, a participant selection module, a grading module, and a results module. The game generation module is configured to receive a first set of parameters from a first sponsor and is configured to receive a second set of parameters from a second sponsor. The sponsor selection module is configured to receive a first set of game selections from the first sponsor and is configured to receive a second set of game selections from the second sponsor. The participant selection module is configured to receive a third set of game selections from a participant. The grading module is configured to generate an evaluation of the first set of game selections, and generate an evaluation of the second set of game selections, and generate an evaluation of the third set of game selections. The results module is configured to provide a comparison of the evaluation of the first set of game selections and the evaluation of the third set of game selections and provide a comparison of the evaluation of the second set of game selections and the third set of game selections.

In some embodiments, a computer system including instructions recorded on a non-transitory computer-readable storage medium and readable by at least one processor. The system may include a game generation module, a sponsor selection module, a participant selection module, a grading module, a results module, and a challenge module. The game generation module is configured to receive a set of parameters from a sponsor. The sponsor selection module is configured to receive a set of game selections from the sponsor. The participant selection module is configured to receive a second set of game selections from a first participant. The grading module is configured to generate an evaluation of the first set of game selections and generate an evaluation of the second set of game selections. The results module is configured to provide a comparison of the evaluation of the first set of game selections and the evaluation of the second set of game selections. The challenge module is configured to allow the first participant to issue a challenge to a second participant.

In some embodiments, a computer system may include instructions recorded on a non-transitory computer-readable storage medium and readable by at least one processor. The system may include a game generation module, a sponsor selection module, a participant selection module, a grading module, a results module, and a challenge module. The game generation module is configured to receive a set of parameters from a sponsor. The sponsor selection module is configured to receive a set of game selections from the sponsor. The participant selection module is configured to receive a second set of game selections from a first participant. The first participant is one of a first team of participants. The grading module is configured to generate an evaluation of the first set of game selections and generate an evaluation of the second set of game selections. The results module is configured to provide a comparison of the evaluation of the first set of game selections and the evaluation of the second set of game selections. The challenge module is configured to allow the first team of participants to issue a team challenge to a second team of participants.

### BRIEF DESCRIPTION OF THE DRAWINGS

FIG. 1 is a schematic diagram of a network according to an embodiment of the invention.

FIGS. 2-4 are block diagrams of systems according to embodiments of the invention.

FIG. 5 is a flow chart of a method according to an embodiment of the invention.

FIGS. 6-18 are various screen shots of user interfaces according to embodiments of the invention.

### DETAILED DESCRIPTION

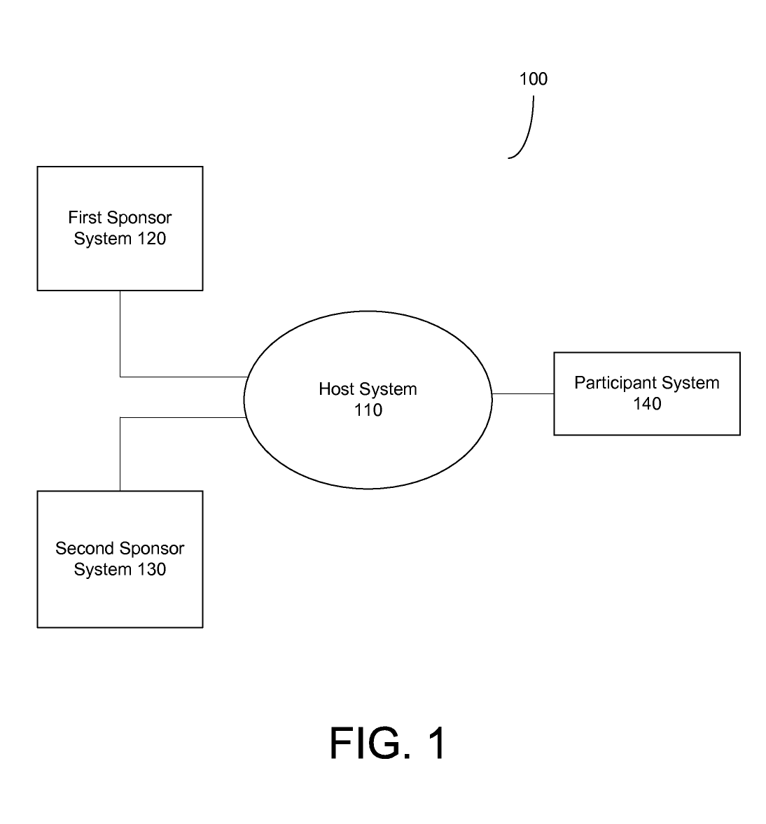

FIG. 1 is a schematic diagram of a network 100 according to an embodiment of the invention. The network 100 includes a host system 110, a first sponsor system 120, a second sponsor system 130, and a participant system 140. While two sponsor systems 120 and 130 are illustrated and described below, the network 100 can include any number of sponsor systems. For example, the network 100 may include a single sponsor system or 10, 20, or more sponsor systems. While only one participant system 140 is illustrated and described below, the network 100 may include any number of participant systems. For example, the network 100 may include 10, 100, 1000 or more participant systems.

In the illustrated embodiment, the first sponsor system 120, the second sponsor system 130, and the participant system 140 are configured to, formed to, or otherwise communicate with the host system 110. For example, as will be described in more detail below, the host system 110 may send requests for information (such as via a survey, a questionnaire, a template, or via any other type of user interface) to the first sponsor system 120, the second sponsor system 130, and the participant system 140. The host system 110 may also receive information from the first sponsor system 120, the second sponsor system 130, and the participant system 140.

The systems 110, 120, 130, and 140 may include computer components, including hardware and software. In some embodiments, the systems 110, 120, 130, and 140 each include a processor. In some embodiments, the processor is a device that is configured to fetch instructions, to execute instructions and/or to access and communicate. In some embodiments, the processor is one of multiple processors in a system (e.g. system 110). In some embodiments, the processor includes a field programmable gate array.

The communication channels between the sponsor systems 120 and 130 and host system 110 may be any type of communication channel. Similarly, the communication channel between the participant system 140 and the host system 110 may be any type of communication channel. For example, the communication channels may be electrical communication channels. The channels may be hardwire channels or may include wireless communication channels. In some embodiments, the communication channel includes the use of the internet or an intranet. In some embodiments, the systems 110, 120, 130, 140 may be physically located at different locations and may communicate via the communication channels.

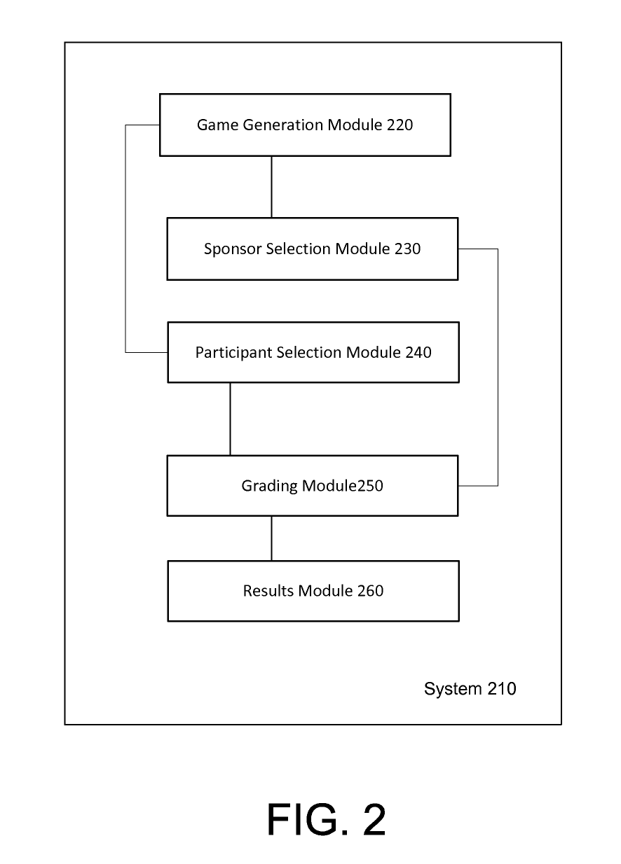

FIG. 2 is a block diagram of a system 210 in accordance with an embodiment of the invention. The system 210 may be incorporated into one of the above described systems. In some embodiments, the system 210 is incorporated into or is a part of the above described host system 110. The system 210 includes a game generation module 220, a sponsor selection module 230, a participant selection module 240, a grading module 250, and a results module 260, each of which will be described in more detail below.

In some embodiments, the system 210 is configured to allow individuals (or participants) and companies or celebrities (or sponsors) to interact and compete against each other using a sports book method or system. In some embodiments, the system 210 may allow an individual (or participant) to challenge or compete against another company or celebrity (or sponsor) each week. As will be described in more detail below, in some embodiments, the challenge is based on fantasy earnings for a specific week. In some embodiments, the individual (or participant) and the company or celebrity (or sponsor) each make their own sports picks and wagers. Through their picks the participant and the sponsor will accrual fantasy dollar earnings (either a profit or a loss). The winner is the one that has the highest fantasy dollars for the specific week of the challenge. For example, if the participant has $125,000 and the sponsor has $100,000, the participant would be deemed the winner for that challenge.

The system 210 can be, or can be included within, for example, a client device and/or a server device. In some embodiments, the system 210 can be, or can be included within, for example, a wired device and/or a wireless device (e.g., wi-fi enabled device) and can be, for example, a computing entity (e.g., a personal computing device, such as a tablet device), a mobile phone, a personal digital assistant (PDA) and/or so forth. The system 210 can be configured to operate based on one or more platforms (e.g., one or more similar or different platforms) that can include one or more types of hardware, software, firmware, operating systems, runtime libraries, and/or so forth. In some embodiments, the system 210 can be integrated with other benefit processing applications (e.g., programs).

Although not shown, the system 210 can be configured to operate within an environment that includes an operating system. In some embodiments, the operating system can be configured to facilitate the functions of the system 210.

In some embodiments, one or more portions of the components or modules of the system 210 illustrated in FIG. 2 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some embodiments, one or more portions of the game generation module 220 can be, or can include, a software module configured for execution by at least one processor (not shown). Similarly, one or more portions of the other modules 230, 240, 250, and 260 can be a software module configured for execution by at least one processor (not shown). In some embodiments, the functionality of the modules or components can be included in different modules and/or components than those shown in FIG. 2. For example, although not shown, the functionality of the game generation module 220 can be included in a different module than the game generation module 220, or can be divided into several different modules.

In some embodiments, the processor is a device that is configured to fetch instructions, to execute instructions and/or to access and communicate. In some embodiments, the processor is one of multiple processors in a system (e.g. system 210). In some embodiments, the processor is an FPGA and/or is incorporated into one of the modules. In some embodiments, the processor is embodied on or includes a substrate such as a semiconductor or a semiconductive substrate.

In the illustrated embodiment, the game generation module 220 is configured to generate or create a game, contest, or challenge. For example, in some embodiments, the game generation module 220 is configured to generate or create a sports book type game or contest. In some embodiments, the game generation module 220 is configured to generate or create a game, contest, or challenge that may be entered into or used by one or more participants.

In some embodiments, the sports book type game or contest allows participants or users to place “wagers” on a sporting event. For example, a participant or user may start with a particular amount of points or “money” (game money, rather than real money) and may be able to use that “money” to place wagers on sporting events. In some embodiments, the participant may be able to select an amount of “money” to wager and may select a team that will win a particular athletic contest. If the team wins, the participant will be awarded an amount of “money” equal to the amount of “money” wagered. If the team loses, the amount of the wager will be deducted from the bankroll of the participant. In some embodiments, the participant may select a team that will win a sporting event (such as a moneyline pick), a team that will win or beat a stated point spread, or may select “over” or “under” a stated score for a sporting event. In some embodiments, the participant may select or pick other items regarding a sporting or other event. For example, in some embodiments, the participant may select or pick a proposition or other type of event associated with a sporting event.

In some embodiments, the game generation module 220 is configured to generate or create a game or contest based on parameters received from a sponsor. For example, the game generation module 220 may communicate with a sponsor system, such as the first sponsor system 120, to request and receive parameters for a game or contest. For example, in some embodiments, the sponsor may indicate or select the length of a game or contest (such as one week, one month, one year, etc.) and the type of picks or selections that may be made by participants (all sports or only a subset of sports such as only a single sport). In some embodiments, the game generation module 220 is configured to provide a series of questions or game options to the sponsor and receive the responses that the sponsor provides.

Additionally, the sponsor may select or set the parameters regarding who will be deemed a winner of the game or contest and what the winner or winners will receive in terms of prizes. For example, in some embodiments, the sponsor may indicate that all participants who beat the sponsor (as will be described in more detail below) during the contest period will be deemed a winner. In some embodiments, the sponsor may indicate that only the top participant will be deemed a winner. In other embodiments, winners may be identified using different criteria.

In some embodiments, the game generation module 220 is configured to communicate with a plurality of sponsors to create games or contests. For example, the game generation module 220 may be configured to communicate with a plurality of sponsor systems, such as the first sponsor system 120 and the second sponsor system 130, to request and receive parameters for games or contests. The game generation module 220 is configured to generate a game or contest for each of the sponsors. For example, the game generation module 220 is configured to create or generate a first game or contest for a first sponsor and a different game or contest for a second sponsor. The first game or contest will created based on the parameters provided by the first sponsor and the second game will be created based on the parameters provided by the second sponsor. The first game or contest may be similar or different than the second game or contest (based on how different the selected parameters are).

Once the game generation module 220 has created a game or contest, the game generation module 220 is configured to communicate with the sponsor selection module 230 and the participant selection module 240. For example, in some embodiments, the game generation module 220 is configured to provide the game or contest or the details of the game or contest to the sponsor selection module 230 and the participant selection module 240.

The sponsor selection module 230 is configured to communicate with the sponsor of the game created by the game generation module 220. For example, in some embodiments, the sponsor selection module 230 is configured to communicate with a system of a sponsor, such as the first sponsor system 120. In some embodiments, the sponsor selection module 230 is configured to communicate with a plurality of sponsors for a plurality of games or contests that have been generated by the game generation module 220.

In some embodiments, the sponsor selection module 230 is configured to receive selections associated with the game or contest from the sponsor. For example, in some embodiments, the sponsor selection module 230 is configured to receive wagers or selections from the sponsor via a sponsor system, such as the first sponsor system 120.

In some embodiments, the sponsor selection module 230 is configured to receive sports book type selections from the sponsor. For example, in some embodiments, the sponsor selection module 230 is configured to receive a wager amount and a team for a specific sporting event. In other embodiments, the sponsor selection module 230 is configured to receive different type of information or selections from the sponsor.

In some embodiments, the sponsor selection module 230 is configured to provide potential selections to the sponsor. For example, in some embodiments, the sponsor selection module 230 is configured to provide a questionnaire or other form that includes a set of potential selections to the sponsor. The sponsor may then reply to the questionnaire or form that includes the set of potential selections to provide the sponsor selection module 230 with the specific selections of the sponsor.

The participant selection module 240 is configured to communicate with the participant of the game created by the game generation module 220. For example, in some embodiments, the participant selection module 240 is configured to communicate with a system of a participant, such as the participant system 140. In some embodiments, the participant selection module 240 is configured to communicate with a plurality of participants of the game created by the game generation module 220. Additionally, in some embodiments, the participant selection module 240 is configured to communicate with a plurality of participants for a plurality of games or contests that have been created by the game generation module 220.

In some embodiments, participant selection module 240 is configured to receive a selection from a participant or participants as to which contests or games the participant or participants would like to take part or participate in. For example, in some embodiments, the participant selection module 240 is configured to allow a participant to search for and select the games or contests that have been created that the participant would like to participate in.

In some embodiments, the participant selection module 240 is configured to allow each participant to enter or participate in only one game or contest. In other embodiments, the participant selection module 240 is configured to allow each participant to enter or participate in any number of games or contests. In some embodiments, the participant selection module 240 is configured to allow each participant to enter more than one game or contest if the participant has an elevated status (for example, is a paying participant). In some embodiments, the participant selection module 240 is configured to allow each participant to identify one game or contest as their primary game or contest. This information may then be provided to the sponsor of the primary game or contest.

In some embodiments, the participant selection module 240 is configured to receive selections associated with the game or contest from the participant. For example, in some embodiments, the participant selection module 240 is configured to receive wagers or selections from the sponsor via a participant system, such as the participant system 140.

In some embodiments, the participant selection module 240 is configured to receive sports book type selections from the participant or participants. For example, in some embodiments, the participant selection module 240 is configured to receive a wager amount and a team for a specific sporting event. In other embodiments, the participant selection module 240 is configured to receive different type of information or selections from the participant or participants.

In some embodiments, the participant selection module 240 is configured to provide potential selections to the participant or participants. For example, in some embodiments, the participant selection module 240 is configured to provide a questionnaire or other form that includes a set of potential selections to the participant or participants. The participant or participants may then reply to the questionnaire or form that includes the set of potential selections to provide the participant selection module 240 with the specific selections of the participant or participants.

The sponsor selection module 230 and the participant selection module 240 are configured to communicate with the grading module 250. The grading module 250 is configured to receive the game or contest selections that are made by the sponsor or sponsors and the participant or the participants and grade or evaluate such selections.

In some embodiments, the grading module 250 is configured to receive the results of the sports or athletic contests. For example, in some embodiments, the grading module 250 is configured to communicate with a sports news service to receive the results of sports or athletic contests. In other embodiments, the grading module 250 is configured to receive date from another source, such the entering of data by an administrator, regarding the outcome or results of sports or athletic contests.

In some embodiments, the grading module 250 is configured to compare the selections made by the sponsors and the participants with the results of the sports or athletic contests. The grading module 250 is configured to deem the selections made by the sponsors and the participants as correct or incorrect. In some embodiments, the grading module 250 is configured to award points or an amount of “money” in the amount of the wager for each correct selection made by the sponsors and the participants. In some embodiments, the grading module 250 is configured to deduct the amount of points or “money” wagered from the sponsors or participants for each incorrect selection.

In some embodiments, the term or period of the game or contest spans several days. For example, in some embodiments, the game or contest may last one week. In such embodiments, the grading module 250 is configured to tally or sum the points over the term or period of the game or contest. For example, the grading module 250 may be able to evaluate the picks or selections of a participant that occur during a given week and provide the results of the selections for the week. In some embodiments, the grading module 250 is configured to calculate and provide a report regarding the selections to the sponsor or to the participant. The results can include the total number of points or “money” won or lost during the period. The results can also include the total number of points or “money” won or lost in each type of sporting event during that period. In other embodiments, the report may include other information such as average size of wager, number of wagers, average number of wagers per day, etc.

In some embodiments, the grading module 250 is configured to communicate with the results module 260. Specifically, in some embodiments, the grading module 250 is configured to provide the evaluations of the sponsor selections and the participant selections to the results module 260. In some embodiments, the evaluations provided by the grading module 250 include an amount of points or “money” won or lost during the contest period by each of the sponsors and each of the participants.

The results module 260 is configured to compare and provide a comparison of the evaluations of the selections made by the sponsors and the participants. For example, in some embodiments, the results module 260 is configured to compare the number of points or “money” won or lost by the sponsors and the participants.

In some embodiments, the results module 260 is configured to determine a winner of the game or contest based on the parameters of the game or contest set by the sponsor. For example, in some embodiments, the results module 260 is configured to determine whether a participant beat a sponsor based on the number of points or “money” won during the contest period. In other embodiments, the results module 260 is configured to rank all of the participants in a particular game or contest based on the number of points or “money” won by each of the participants during the contest period.

In some embodiments, the results module 260 is configured to communicate with the sponsors as well as the participants of the games or contests. In some embodiments, the results module 260 is configured to provide the results of the games or contests to the sponsors and to the participants. For example, the results module 260 may generate an output, such as a listing of the results of the game or contest and may display output, either in the form of a printout or an electronic document that may be displayed on a computer screen, to the sponsors and the participants of the games or contests. In some embodiments, the results module 260 may include a display or may be configured to communicate with a display located at a site or location of a sponsor (such as within a restaurant or a sports bar). In such embodiments, the results module 260 may be configured to display or identify the winners of the game or contest or may be configured to provide the current standings of the game or contest. In some embodiments, the results module 260 is configured to cause an audio or visual output when a winner of a game or contest enters a site or location of a sponsor (such as a restaurant or sports bar). In some embodiments, the results module 260 is configured to identify a winner when the winner provides a name at the location of the sponsor (for example, when the winner puts in his or her name for a table or uses his or her credit card). For example, in some such embodiments, the results module 260 may include or be configured to communicate with a bell, whistle, light, or other type of noise maker or light emitting device to identify a winner of a game or contest. In some embodiments, the identification of the winner may allow the winner to enjoy benefits or privileges at the location of the sponsor. For example, the winner may receive discounts, be treated as a VIP (very important person), have a photo or video taken, or participate in an activity with an employee of the sponsor.

In some embodiments, the results module 260 is configured to provide year-to-date or total history data to the sponsors and the participants of the games or contests. For example, in some embodiments, the results module 260 is configured to store, tabulate, and provide data regarding how a particular participant or sponsor has done in games or contests entered during a particular year or for as long as the participant or sponsor has been entering games or contests. In some embodiments, the results module 260 is configured to store, tabulate, and provide a list of the top participants on a year-to-date basis, provide a list of the top participants on a consecutive game or contest win streak basis, or provide a list of the top participants on the number of career game or contest win basis.

In some embodiments, the results module 260 is configured to provide details to the sponsors as to which participants entered into the games or contests created by the sponsor. For example, in some embodiments, the results module 260 is configured to communicate with the sponsor such as via a sponsor system (for example, the first sponsor system) to provide details of the participants. In some embodiments, the results module 260 may provide information regarding the participants to sponsor. For example, the results module 260 may identify which or how many participants identified the game or contest as the primary or preferred game or contest of the participant.

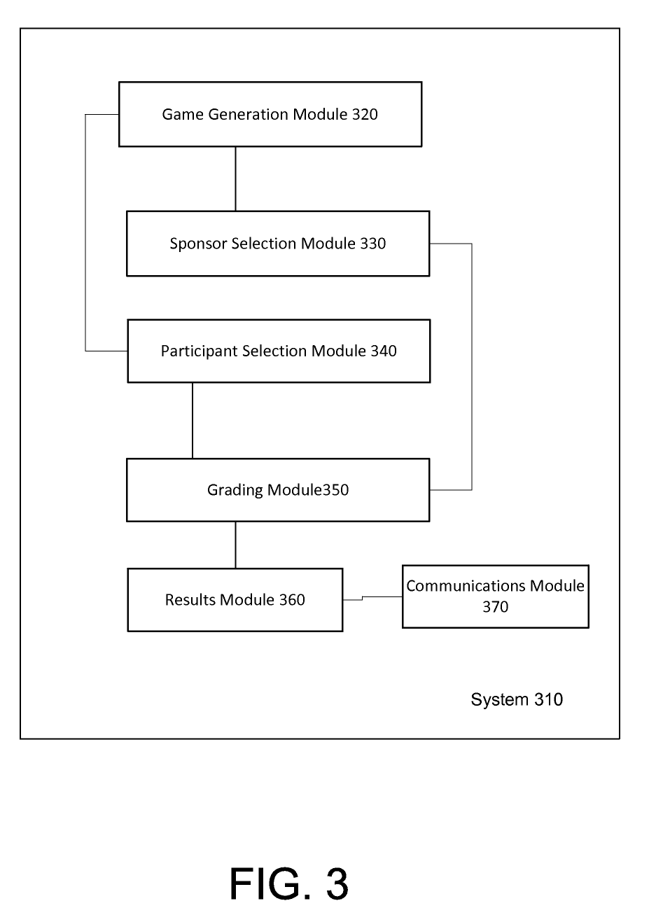

FIG. 3 is a schematic diagram of a system 310 according to an embodiment of the invention. In the illustrated embodiment, the system includes a game generation module 320, a sponsor selection module 330, a participant selection module 340, a grading module 350, and a results module 360. These modules 320, 330, 340, 350, and 360 may function in a manner similar to those described above. The system 310 also includes a communications module 370.

The communications module 370 is configured to allow the sponsors and the participants to communicate with each other. In some embodiments, the communications module 370 is configured to allow for messages to be sent from sponsors to the participants and vice versa. For example, the sponsors may be able to provide information about their game or contest to the participants. Additionally the sponsors may be able to provide information about their business or themselves to the participants. Also, the sponsors may be able to notify the winning participants and facilitate the transfer of any prize associated with the game or contest. For example, in some embodiments, the communications module 370 is configured to send (or cause to be sent) an electronic message (such as an email) to the winner or winners of a contest. In some embodiments, the electronic message may include a gift card or coupon. For example, the email may include a gift card or coupon attached to the email. In some embodiments, the communications module 370 is configured to send (or cause to be sent) an electronic newsletter to all of the participants of the game or contest. The newsletter may identify the winners of the particular game or contest. In some embodiments, the communications module 370 is configured to identify the winner or winners of a game or contest on the internet such as on social media sites.

In some embodiments, the communications module 370 allows the sponsors and the participants to create a profile or profile page. The profile or profile pages may then be able to be searched and viewed by other sponsors and participants.

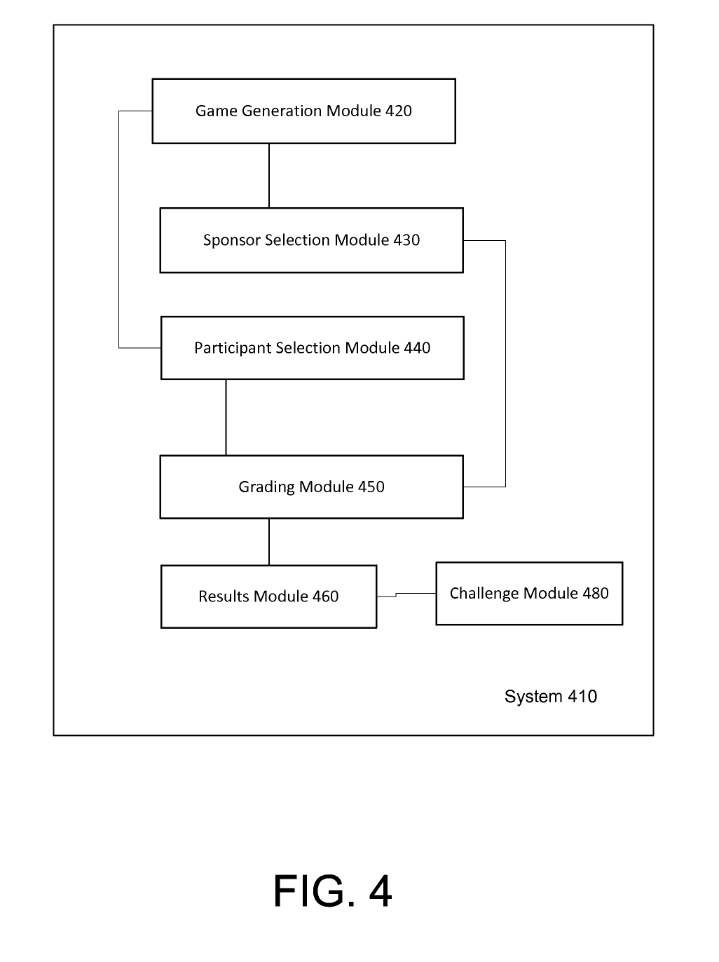

FIG. 4 is a schematic diagram of a system 410 according to an embodiment of the invention. In the illustrated embodiment, the system 410 includes a game generation module 420, a sponsor selection module 430, a participant selection module 440, a grading module 450, and a results module 460. These modules 420, 430, 440, 450, and 460 may function in a manner similar to those described above. The system 410 also includes a challenge module 480.

In some embodiments, the challenge module 480 is configured to allow participants to compete amongst each other in head to head action (or side action). In some embodiments, the challenge module 480 is configured to allow groups or teams of participants to compete against other groups of teams (team challenges). In some embodiments, the challenge module 480 is configured to allow participants to compete individually (head to head action or side action) and in groups or teams (team challenges).

In some embodiments, the challenge module 480 is configured to allow a first participant to challenge a second participant in a head to head challenge (side action). For example, in some embodiments, a first participant may issue a challenge to a second participant with respect to a specific athletic event. For example, the first participant may wager a specific amount of points or “money” with the second participant for a specific athletic event. If the team or position of the first participant wins then the first participant will be granted the wagered amount of points or “money” and the second participant's number of points or “money” will be decreased by the wager amount.

In some embodiments, the first participant may search for other participants to challenge. In some embodiments, the first participant may challenge a friend or an acquaintance to a head to head challenge. In some embodiments, once a challenge is issued from a first participant to a second participant, the second participant may accept or decline the challenge.

If the challenge is accepted by the second participant, then the challenge module 480 is configured to receive the selections made by the first participant and the second participant. The challenge module 480 is configured to determine a winner between the first participant and the second participant based on the selections of the participants and the results of the athletic event.

The challenge module 480 is configured to award points or “money” to the winning participant and deduct points or “money” from the losing participant. In some embodiments, the points or “money” won or lost in head to head challenges or side action do not affect the participants with respect to the games or contests that have been entered into by the participants.

In some embodiments, the challenge module 480 is configured to store the results of the head to challenges amongst the participants and provide the results to the participants. For example, in some embodiments, the challenge module 480 is configured to communicate with the participants and provide an indication of how each of the participants is performing in the head to head challenges with the other participants.

In some embodiments, the challenge module 480 is configured to provide a display of the historical head to head challenges between the participants. For example, in some embodiments, the challenge module 480 is configured to provide a win/loss record of a participant against the other participant in head to head challenges. In other embodiments, the challenge module 480 is configured to tabulate total points or “money” won or lost in the head to head challenges. For example, the challenge module 480 may be configured to tabulate, store, and provide a total number of points or “money” won or lost by a first participant in head to head challenges against a second participant.

In some embodiments, the challenge module 480 is configured to allow a first team of participants to challenge a second team of participants in a challenge. For example, in some embodiments, a first team of participants may issue a challenge to a second team of participants with respect to athletic events for a period of time (such as a week or a month).

In some embodiments, the challenge module 480 allows groups of participants to form teams. In some embodiments, individual participants may search for other participants and request or invite such other participants to join a team. The challenge module 480 may also allow teams to search for other teams to challenge. In some embodiments, each team has a team captain or leader. In some embodiments, only the team captains or leaders may issue or accept challenges. In other embodiments, any of the members of the teams may issue or accept challenges.

If a team challenge is accepted, then the challenge module 480 is configured to receive the selections made by the first team of participants and the second team of participants. The challenge module 480 is configured to determine a winner between the first participant and the second participant based on the selections of the participants and the results of the athletic event. For example, in some embodiments, the selections of the participants are wagers on athletic events. In some embodiments, the winner of the challenge is the team of participants that has the highest average points of “money” won in wagers during the period of time. In other words, the winning team is the team that has the average points or “money” won during the period (total money won by the team of participants divided by the number of participants on the team). In other embodiments, the winner of the challenge is team that has the highest number of total points or “money” won during the challenge period.

In some embodiments, the challenge module 480 is configured to store the results of the team challenges provide the results to the each participant of the teams of participants. For example, in some embodiments, the challenge module 480 is configured to communicate with the participants and provide an indication of how each of the teams of participants are performing in the team challenges with the other teams of participants.

In some embodiments, the challenge module 480 is configured to provide a display of the historical team challenges between the teams of participants. For example, in some embodiments, the challenge module 480 is configured to provide a win/loss record of a team of participants against the other teams of participants.

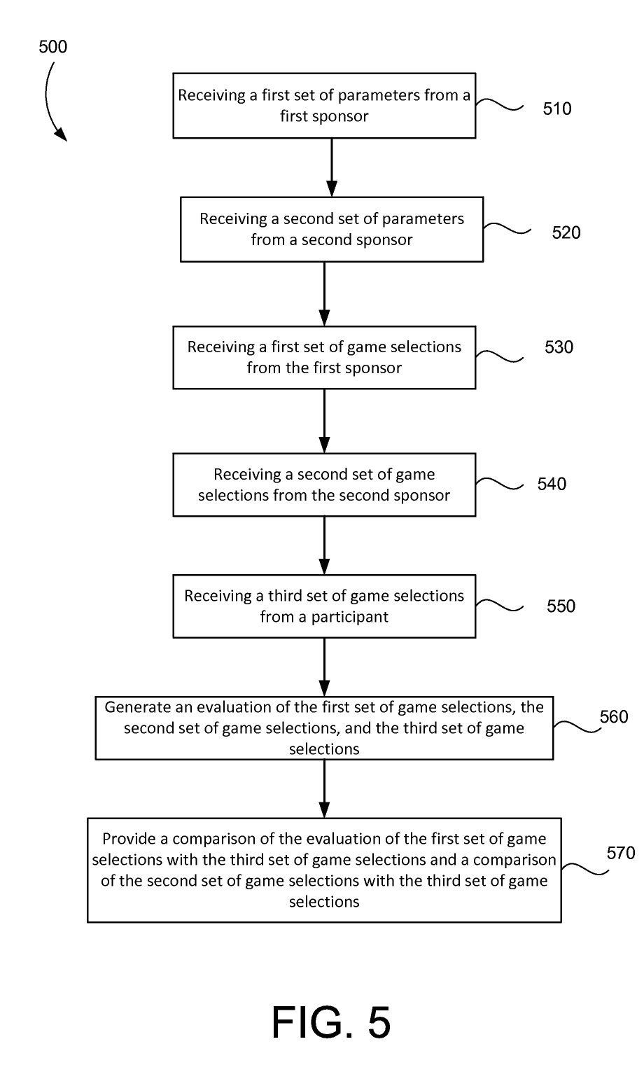

FIG. 5 is a flow chart of a method 500 according to an embodiment of the invention. At 510, a first set of parameters are received from a first sponsor. As described above, the first set of parameters may be received from a first sponsor system. At 520, a second set of parameters are received from a second sponsor. In some embodiments, the first sponsor is different than the second sponsor. As described above, the second set of parameters may be received from a second sponsor system. Games or contests may be generated or formed based on the sets of parameters received from the first sponsor and the second sponsor.

At 530, a first set of game selections are received from the first sponsor. At 540, a second set of game selections are received from the second sponsor. At 550, a third set of game instructions are received from a participant. As described above, the game selections may include any number of selections based on athletic contests or other types of events. In some embodiments, the game selections include a wager and a selection of a team to win an athletic event (or cover a spread of an athletic event).

At 560, evaluations of the game selections are generated. Specifically, in some embodiments, a comparison is made as to the game selections and the outcomes of the athletic contests or events. At 570, a comparison is made of the evaluations. For example, in some embodiments, a comparison is made of the evaluation of the first game selections and the evaluation of the third game selections. In some embodiments, a comparison is made of the evaluation of the second game selections and the third game selections.

In some embodiments, the method includes receiving a request to initiate a head to head challenge or contest or a team challenge or contest. In such embodiments, the methods may include receiving a request to initiate a challenge (individual or team) and sending an invitation to the challenge (to be received and accepted by the participant being challenged). In some embodiments, the method includes scoring or tabulating the challenge. In some embodiments, the method includes providing the results of the challenge to the participants and storing the results.

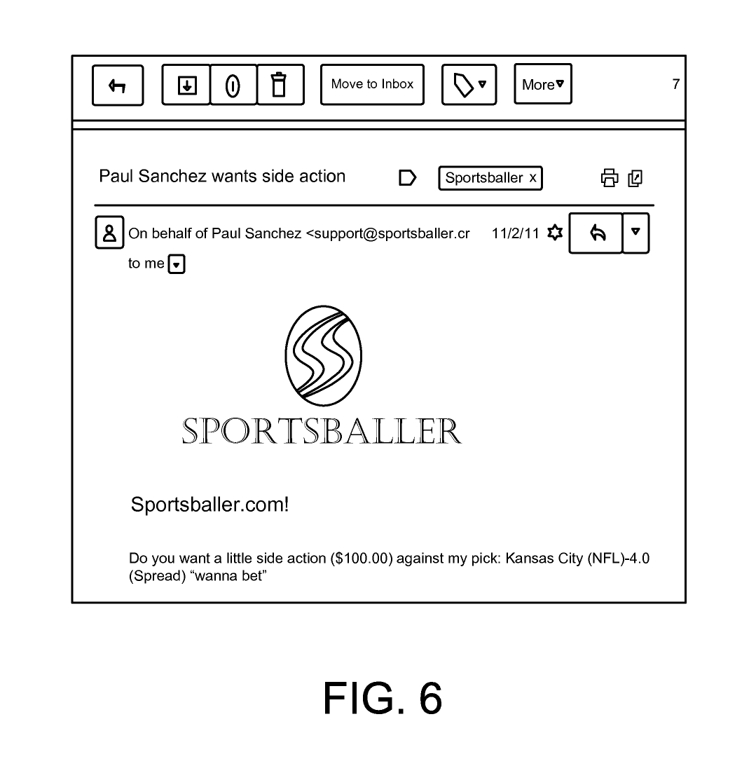

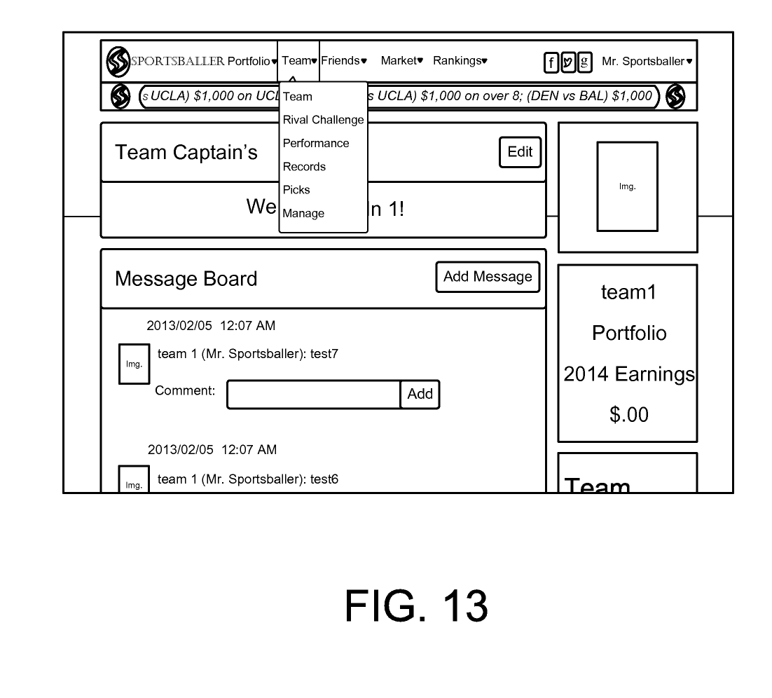

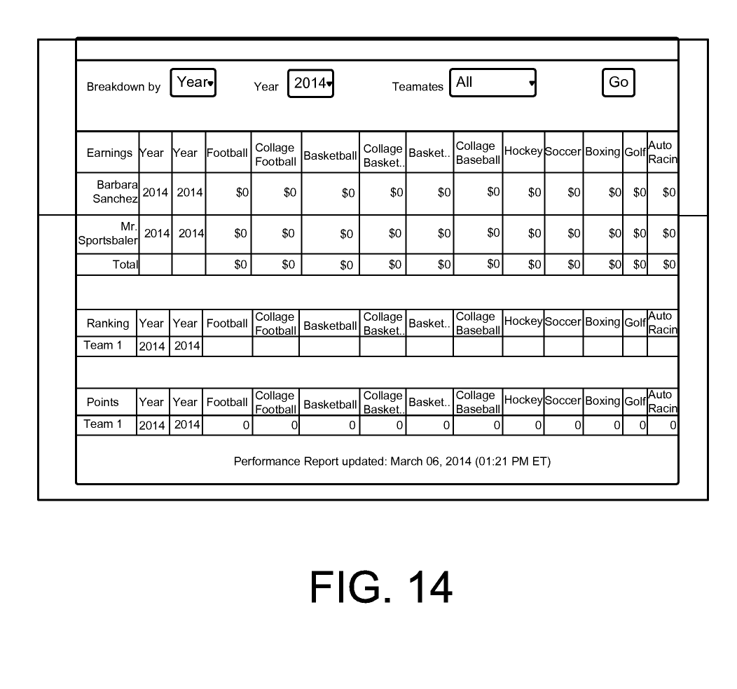

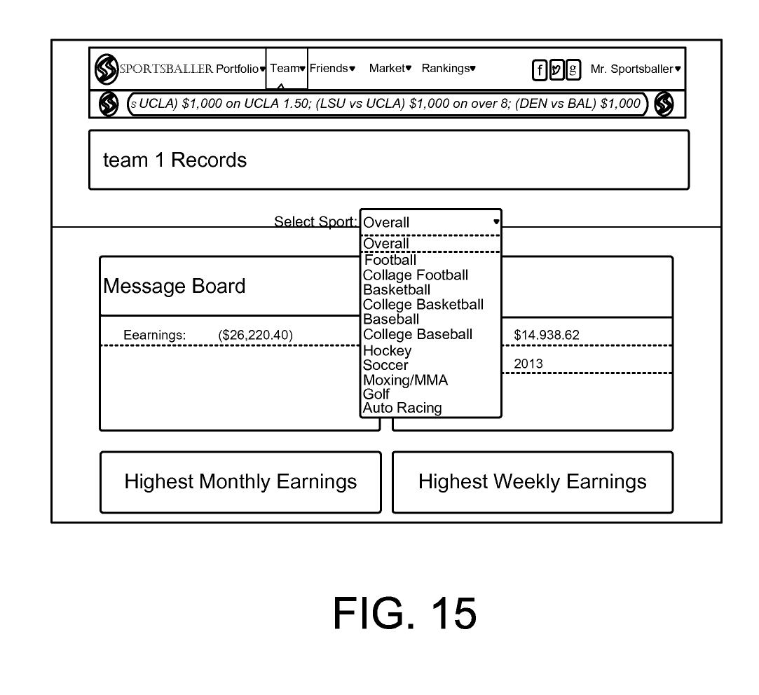

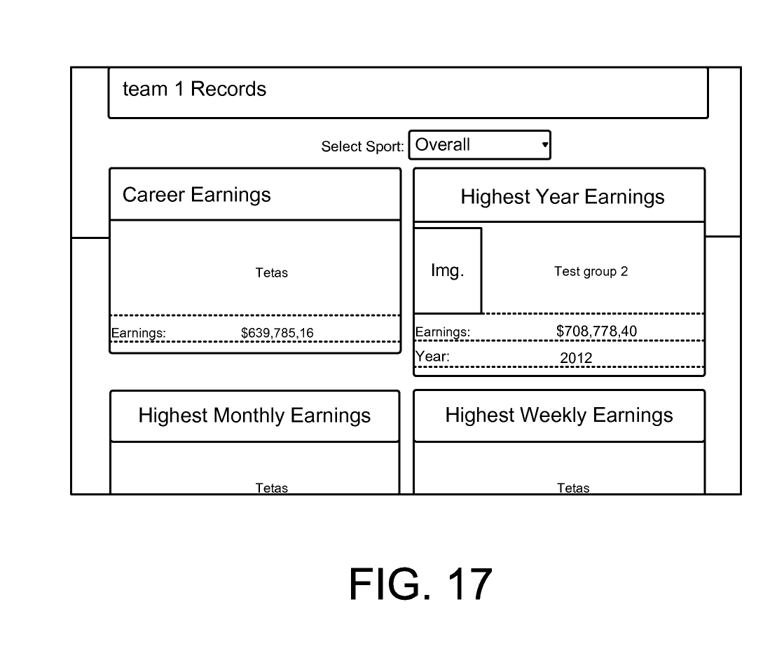

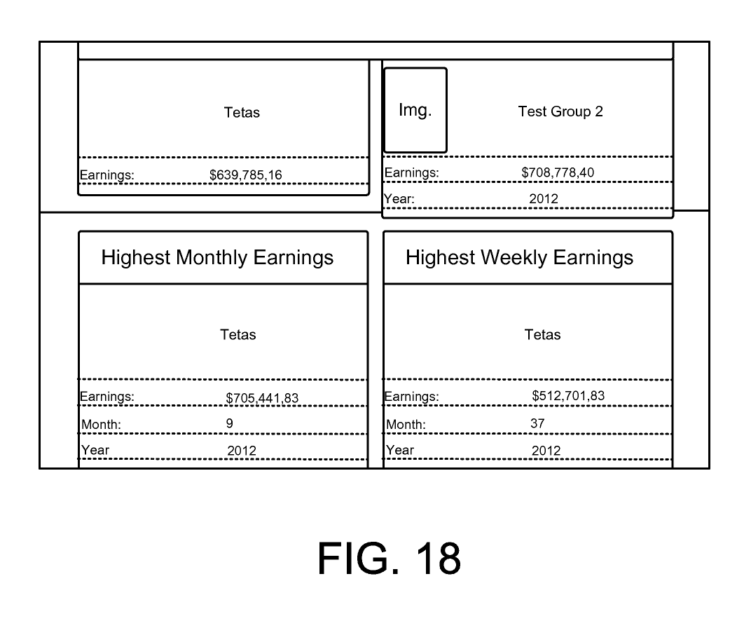

FIGS. 6-18 are various screen shots of interfaces (such as graphical user interfaces) that are configured to interact with the sponsors and/or the participants.

FIG. 6 is a screen shot or display of a challenge that has been issued to one of the participants. As described above, the challenge module may communicate with a participant who has been offered a challenge and such person may accept or decline such challenge. This message may be sent to the participate via email or may be displayed on the home or profile page of the participant.

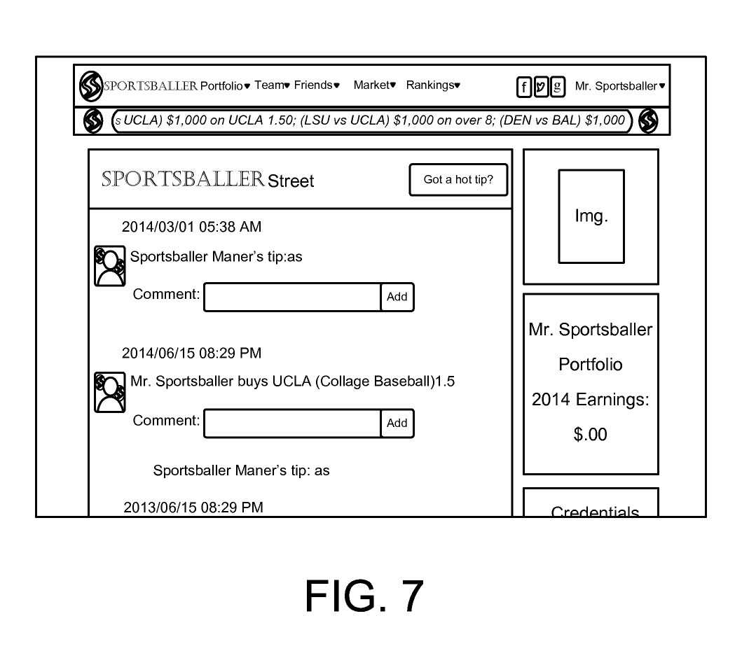

FIG. 7 is a sample screen shot of a home page or profile of a participant.

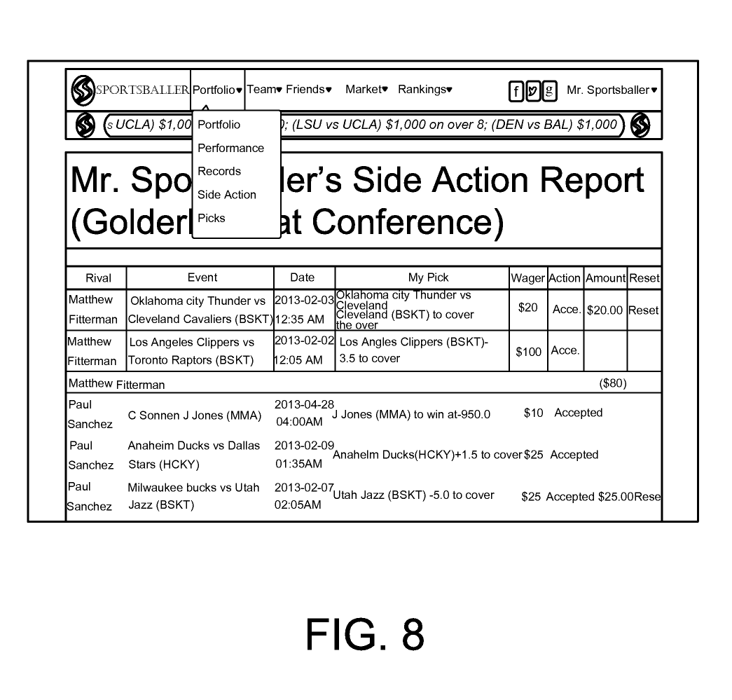

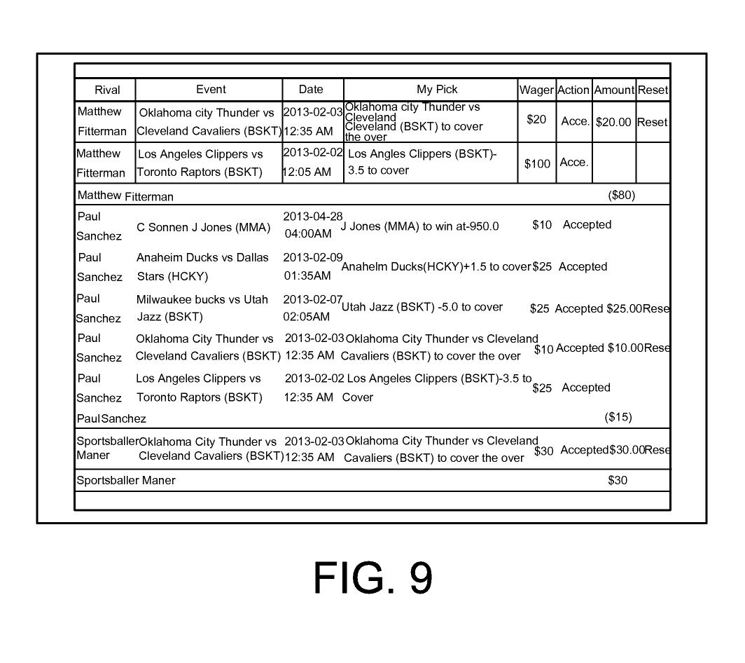

FIGS. 8-9 are screen shots of a display that provide a participant with their results from individual challenges. As described above, in some embodiments, the challenge module is configured to tabulate and store the history or results of the challenges that a participant has participated in. In some embodiments, the challenge module is also configured to provide a display or output to the participant that lists or summarizes the challenge results

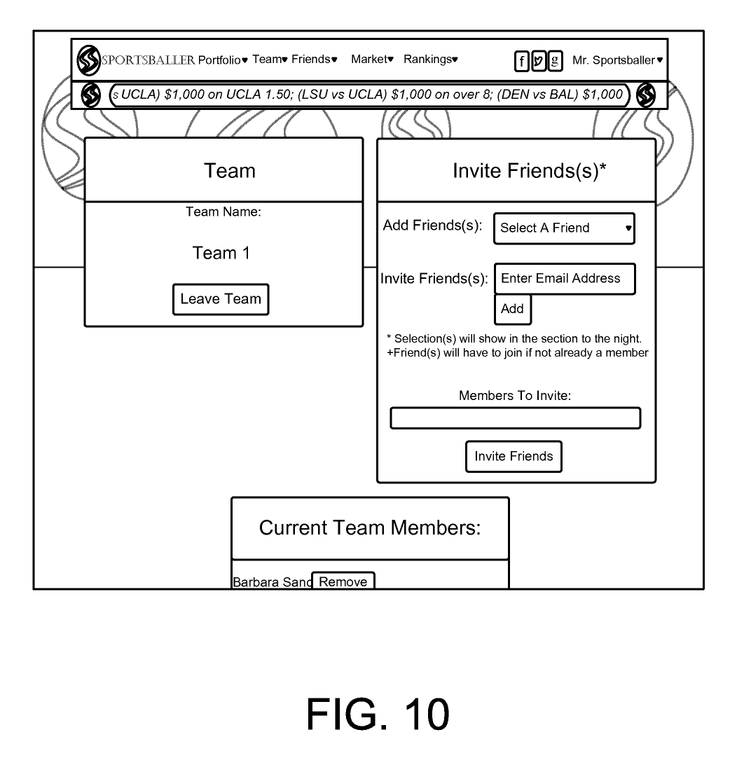

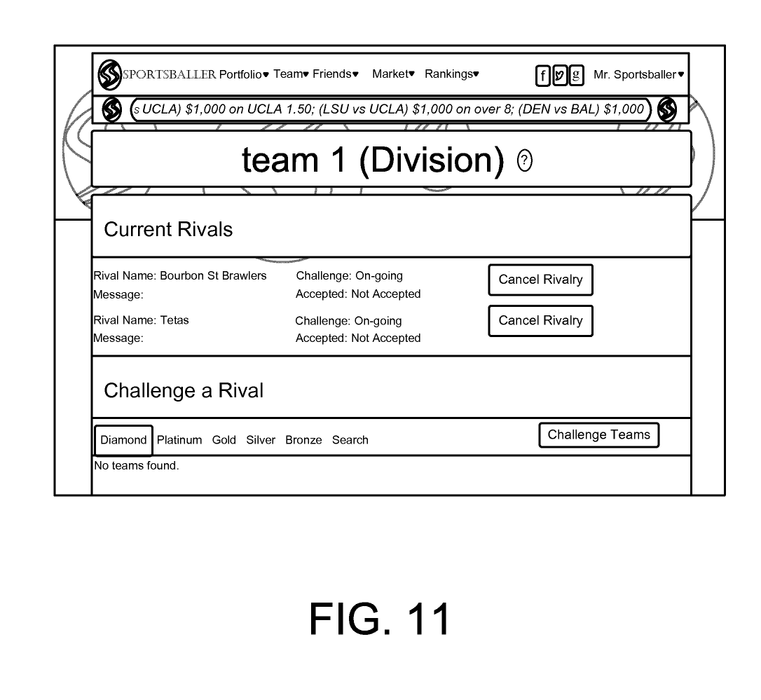

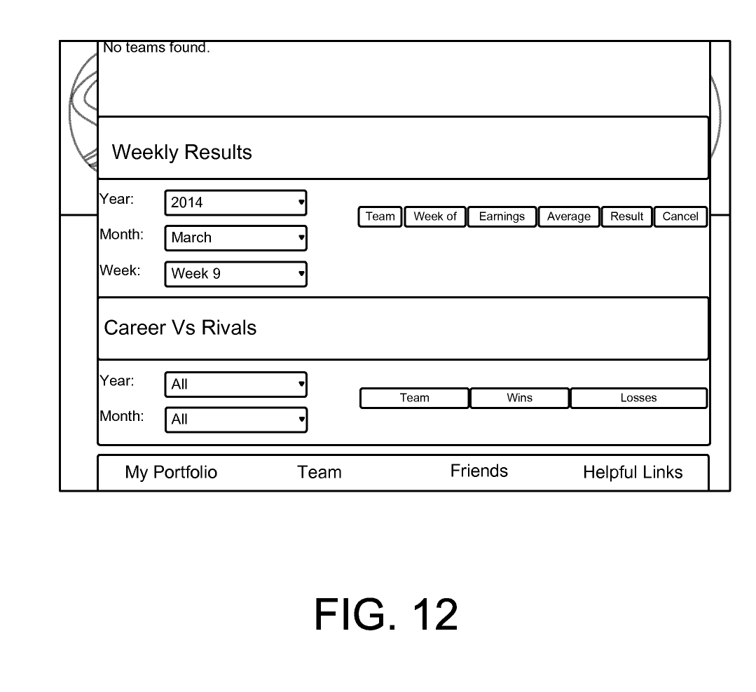

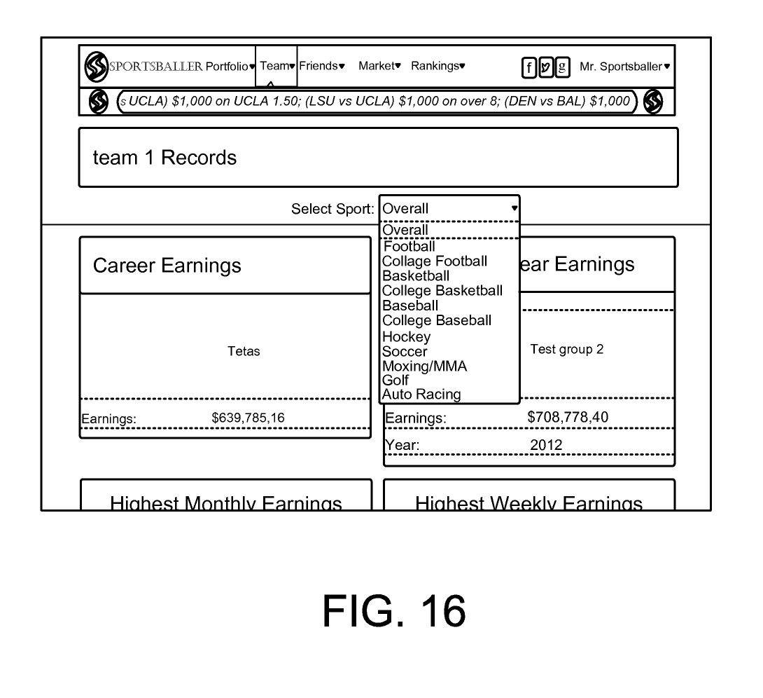

FIGS. 10-18 are screen shots that provide members of a team with information and results from team challenges. As discussed in detail above, in some embodiments, the challenge module is configured to interact with the participants of various teams to tabulate, store, and provide results of team challenges. FIG. 10 is a screen shot that provides information about a team that a participant is associated with. FIG. 11 is a screen shot that provides information about teams that are rivals of the team that the participant is associated with. FIGS. 12-18 are screen shots of displays that provide the participant with results of the team challenges. As best illustrated in FIG. 16, a participant may view or filter the results of the challenges according to sport. Similarly, in some embodiments, participants may also view or filter their results by sport (or may view overall results).

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device (computer-readable medium) or in a propagated signal, for processing by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Methods or steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user ca provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments. It should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

What is claimed is:

1. A computer system including instructions recorded on a non-transitory computer-readable storage medium and readable by at least one processor, the system comprising:
a game generation module configured to receive a first set of parameters from a first sponsor and configured to receive a second set of parameters from a second sponsor;
a sponsor selection module configured to receive a first set of game selections from the first sponsor and configured to receive a second set of game selections from the second sponsor;
a participant selection module configured to receive a third set of game selections from a participant;
a grading module configured to generate an evaluation of the first set of game selections, and generate an evaluation of the second set of game selections, and generate an evaluation of the third set of game selections; and
a results module is configured to provide a comparison of the evaluation of the first set of game selections and the evaluation of the third set of game selections and provide a comparison of the evaluation of the second set of game selections and the third set of game selections.

2. The computer system of claim 1, wherein the first set of parameters includes a selection of a single sport.

3. The computer system of claim 1, wherein the first set of parameters includes a selection of a plurality of sports.

4. The computer system of claim 1, wherein the first set of game selections includes a wager amount and a sports team.

5. The computer system of claim 1, wherein the first set of game selections includes a selection of a sports team for an athletic competition, the evaluation of the first set of game selections includes a determination of whether the sports team was victorious in the athletic competition.

6. The computer system of claim 1, wherein the first set of game selections includes a selection of a sports team for an athletic competition against a stated point spread, the evaluation of the first set of game selections includes a determination of whether the sports team was victorious in the athletic competition against the stated point spread.

7. The computer system of claim 1, wherein the results module is configured to provide the comparison of the evaluation of the first set of game selections and the evaluation of the third set of game selections to the first sponsor.

8. The computer system of claim 1, wherein the results module is configured to provide the comparison of the evaluation of the first set of game selections and the evaluation of the third set of game selections to the first sponsor and to the participant, the results module is configured to provide the comparison of the evaluation of the second set of game selections and the evaluation of the third set of game selections to the second sponsor and the participant.

9. The computer system of claim 1, further comprising:
a communications module configured to allow the first sponsor to communicate with the participant and allow the second sponsor to communicate with the participant.

10. A computer system including instructions recorded on a non-transitory computer-readable storage medium and readable by at least one processor, the system comprising:
a game generation module configured to receive a set of parameters from a sponsor;
a sponsor selection module configured to receive a set of game selections from the sponsor;
a participant selection module configured to receive a second set of game selections from a first participant;
a grading module configured to generate an evaluation of the first set of game selections and generate an evaluation of the second set of game selections;
a results module is configured to provide a comparison of the evaluation of the first set of game selections and the evaluation of the second set of game selections; and
a challenge module is configured to allow the first participant to issue a challenge to a second participant.

11. The computer system of claim 10, wherein the challenge module is configured to allow the second participant to accept or reject the challenge issued by the first participant.

12. The computer system of claim 10, wherein the challenge module is configured to receive a third set of game selections from the first participant and a fourth set of game selections from the second participant, the challenge module is configured to generate results of the challenge by evaluating the third set of game selections and the fourth set of game selections.

13. The computer system of claim 12, wherein the challenge module is configured to store the results of the challenge.

14. The computer system of claim 12, wherein the challenge module is configured to communicate the results of the challenge with the first participant and the second participant.

15. A computer system including instructions recorded on a non-transitory computer-readable storage medium and readable by at least one processor, the system comprising:
a game generation module configured to receive a set of parameters from a sponsor;
a sponsor selection module configured to receive a set of game selections from the sponsor;
a participant selection module configured to receive a second set of game selections from a first participant, the first participant being one of a first team of participants;
a grading module configured to generate an evaluation of the first set of game selections and generate an evaluation of the second set of game selections;
a results module is configured to provide a comparison of the evaluation of the first set of game selections and the evaluation of the second set of game selections; and
a challenge module is configured to allow the first team of participants to issue a team challenge to a second team of participants.

16. The computer system of claim 15, wherein the challenge module is configured to allow the second team of participants to accept or reject the team challenge issued by the first team of participants.

17. The computer system of claim 15, wherein the challenge module is configured to store results of the team challenge.

18. The computer system of claim 15, wherein the challenge module is configured to communicate results of the team challenge with the first team of participants and the second team of participants.
